(19) United States
(12) Patent Application Publication
(10) Pub. No.: US 2023/0090533 A1
(43) Pub. Date: Mar. 23, 2023

(54) 3DP PREPARATION PROCESS OF HIGH-STRENGTH RAPID-DISSOLVING MAGNESIUM ALLOY FOR UNDERGROUND TEMPORARY PLUGGING TOOL

(71) Applicant: Chongqing University, Chongqing (CN)

(72) Inventors: Jingfeng WANG, Chongqing (CN); Chen SU, Chongqing (CN); Kai MA, Chongqing (CN); Hongyun LI, Chongqing (CN); Chaoneng DAI, Chongqing (CN); Jinxing WANG, Chongqing (CN)

(73) Assignee: Chongqing University, Chongqing (CN)

(21) Appl. No.: 17/836,884

(22) Filed: Jun. 9, 2022

(30) Foreign Application Priority Data
Sep. 15, 2021 (CN) 202111082010.0

(51) Int. Cl. C09K 8/42; B33Y 10/00; B33Y 40/20; B33Y 50/00; B33Y 70/10; B33Y 80/00

(52) U.S. Cl. CPC C09K 8/426; B33Y 10/00; B33Y 40/20; B33Y 50/00; B33Y 70/10; B33Y 80/00

(57) ABSTRACT

A 3DP preparation process of a high-strength rapid-dissolving magnesium alloy for an underground temporary plugging tool is disclosed by the present disclosure, comprising the following steps: 1) evenly mixing ingredients of material components; 2) importing the shape of a product needing to be printed into a computer control system, and printing alloy powder and glue in a 3D printer in an alternate spraying molding mode to obtain a blank with the needed shape; 3) drying the blank obtained in the step 2) and then carrying out degreasing and sintering in a protective atmosphere or vacuum; and 4) sintering the blank obtained in the step 3) at a high temperature of 570° C.-680° C. in the protective atmosphere or vacuum and then cooling to a room temperature.

### CROSS REFERENCE TO RELATED APPLICATION

This patent application claims the benefit and priority of Chinese Patent Application No. 202111082010.0, filed on Sep. 15, 2021, the disclosure of which is incorporated by reference herein in its entirety as part of the present application.

### TECHNICAL FIELD

The present disclosure relates to the technical field of magnesium alloy 3D printing technologies, and in particular relates to a 3DP preparation process of a high-strength rapid-dissolving magnesium alloy for an underground temporary plugging tool.

### BACKGROUND ART

Fracturing technology is the core technology to develop oil and gas resources, and underground temporary plugging tools (frac balls and bridge plugs) are the key factors to determine whether the staged fracturing is successful or not.

In the new technology of multi-stage sliding sleeve staged fracturing, the frac ball and the bridge plug play two main roles: the first is to open the sliding sleeve at each stage, thus fracturing the rock of each production layer; and the second is to isolate the fracturing fluid. Therefore, the underground temporary plugging tool requires a higher compressive strength, and the pressure in an oil tube in an oil well needs to be released after all fracturing operations are finished, thus facilitating the production of the oil-gas well at a later stage. The conventional method at present is to discharge the frac ball from a wellhead in a flowback mode by utilizing a pressure difference between oil-gas beds and the oil tube. However, due to the factors of formation pressure and site construction pressure, the frac ball may be stuck, leading to unsuccessful flowback; or drilling and grinding are carried out to keep the shaft smooth, but this process may prolong the construction period, and has a high requirement for a drilling tool, leading to great increase in the cost and risk. Therefore, an ideal underground temporary plugging tool should be able to withstand the high pressure generated during the fracturing construction process and disappear automatically after the fracturing operation is finished; the flowback process of the underground temporary plugging tool is avoided, and then the construction cost and risk can be effectively reduced, the construction period can be shortened, and the construction efficiency can be improved.

The magnesium alloy for preparing the underground temporary plugging tool on the existing market is low in strength and slow in corrosion rate, which affects the extraction efficiency. Moreover, the underground temporary plugging tool on the market at present is mainly produced through machining; however, the underground temporary plugging tool is relatively complex, and the machining still has a certain difficulty. Especially such rapid-corroding alloy is highly susceptible to corrosion during machining, thus affecting the machining process. Therefore, the development of a magnesium alloy which is high in strength and rapid in dissolution rate and capable of rapidly preparing an underground temporary plugging tool according to the needs of users and a preparation method of the magnesium alloy are of great significance for fracturing extraction of the oil and gas resources, and the magnesium alloy and the preparation method thereof have great prospects for application in the field of oil and gas extraction.

### SUMMARY

For the disadvantages in the prior art, an objective of the present disclosure is to provide a 3DP preparation process of a high-strength rapid-dissolving magnesium alloy for an underground temporary plugging tool to solve the problem that the underground temporary plugging tool in the prior art is complex in manufacturing process and difficult in machining preparation.

To solve the technical problem, the present disclosure adopts the following technical solutions:

A 3DP preparation process of high-strength rapid-dissolving magnesium alloy for an underground temporary plugging tool comprises the following steps:

1) uniformly mixing ingredients of material components;

2) importing the shape of a product needing to be printed into a computer control system, and printing alloy powder and glue in a 3D printer in an alternate spraying molding mode to obtain a blank with the needed shape;

3) drying the blank obtained in the step 2) and then carrying out degreasing and sintering in a protective atmosphere or vacuum; and

4) sintering the blank obtained in the step 3) in the protective atmosphere or vacuum at a high temperature of 560° C.-680° C. and then cooling to room temperature.

A high-strength rapid-dissolving magnesium alloy for a underground temporary plugging tool is further provided by the present disclosure, which is prepared through the 3DP preparation process of the high-strength rapid-dissolving magnesium alloy for the underground temporary plugging tool, and is prepared from powder and auxiliary materials, wherein the powder comprises the following components in percentage by weight: one of Cu, Fe, Ni, and the use amount thereof is 0.1 wt %-20 wt %; Al is 0.5 wt %-20 wt %; Zn is 0.1 wt %-10 wt %; the rest is magnesium alloy powder; and the auxiliary material is glue.

Compared with the prior art, the present disclosure has the following beneficial effects:

The alloy sample prepared by the preparation process has the effect of second phase reinforcement, and these reinforced phases can improve the corrosion efficiency of the alloy at the same time. In addition, the alloy prepared in accordance with the present disclosure has certain voids, can be self-densified in a high-pressure environment instead of fragmentation, has a large contact area with the fracturing fluid due to the voids thereof, and has a higher degradation rate than that of a traditional fracturing product; and the extraction efficiency can be effectively improved.

### BRIEF DESCRIPTION OF THE DRAWINGS

FIG. 1 is a diagram of mechanical properties of embodiments 1-4.

FIG. 2 is a diagram of mechanical properties of embodiments 5-8.

FIG. 3 is a diagram of mechanical properties of embodiments 9-12.

FIG. 4 is SEM images of the embodiments 1-4, wherein (4a) is an embodiment 1, (4b) is an embodiment 2, (4c) is an embodiment 3, and (4d) is an embodiment 4.

FIG. 5 is SEM images of embodiments 5-8, wherein (5a) is an embodiment 5, (5b) is an embodiment 6, (5c) is an embodiment 7, and (5d) is an embodiment 8.

FIG. 6 is SEM images of embodiments 9-12, wherein (6a) is an embodiment 9, (6b) is an embodiment 10, (6c) is an embodiment 11, and (6d) is an embodiment 12.

FIG. 7 is a diagram of corrosion rates of the embodiments 1-4.

FIG. 8 is a diagram of corrosion rates of the embodiments 5-8.

FIG. 9 is a diagram of corrosion rates of the embodiments 9-12.

### DETAILED DESCRIPTION OF THE EMBODIMENTS

The present disclosure is further illustrated below with reference to the accompanying drawings and embodiments.

### 1. A 3DP Preparation Process of a High-Strength Rapid-Dissolving Magnesium Alloy for an Underground Temporary Plugging Tool

1) Uniformly mixing raw alloy powder.

2) Importing the shape of a product needing to be printed into a computer control system, printing the alloy powder and glue in a 3D printer in an alternate spraying molding mode to obtain a blank with needed shape. Wherein the alloy powder is loaded into a metal charging barrel of the 3D printer, and the glue is loaded into a glue charging barrel in the 3D printer, the alternate spraying comprises the following steps: uniformly paving a layer of alloy powder on a powder bed, and then spraying a layer of glue on the layer of alloy powder, and then spraying a layer of alloy powder on the glue layer, and then spraying a layer of glue; the alloy powder and glue are alternately sprayed to obtain the blank. The glue is water-based low-molecular alcohol glue.

3) Drying the blank obtained in the step 2), and then carrying out degreasing and sintering on the blank in a protective atmosphere or vacuum. Wherein the blank is dried in the air at 70° C.-160° C. for 2 h-6 h. The dried blank is degreased and sintered in the protective atmosphere or vacuum at 250° C.-400° C. for 0.5 h-10 h.

4) Sintering the blank obtained in the step 3) in the protective atmosphere or vacuum at a high temperature of 550° C.-680° C. and then cooling to room temperature. Wherein the blank is sintered in the protective atmosphere or vacuum at 550° C.-680° C. for 3-100 h. The shielding gas is inert gas.

### 2. A High-Strength Rapid-Dissolving Magnesium Alloy for an Underground Temporary Plugging Tool

A high-strength rapid-dissolving magnesium alloy for an underground temporary plugging tool is further provided, which is prepared through the 3DP preparation process of the high-strength rapid-dissolving magnesium alloy for the underground temporary plugging tool, and is prepared from powder and auxiliary materials, wherein the powder comprises the following components in percentage by weight: one of Cu, Fe, Ni, and the use amount thereof is 0.1 wt %-20 wt %; Al is 0.5 wt %-20 wt %; Zn is 0.1 wt %-10 wt %; the rest is magnesium alloy powder; and the auxiliary material is glue.

Wherein the Cu powder, the Fe powder, and the Ni powder are 150 meshes, and the magnesium alloy powder is 25-500 microns.

### 3. Embodiments and Comparative Examples

The blank is obtained through the method of the present disclosure, and then is sintered through the sintering process of the present disclosure to obtain the embodiments 1-12.

TABLE 1

| Embodiment | Cu | Fe | Ni | Al | Zn |
|---|---|---|---|---|---|
| 1 | 1 wt % | — | — | 9.08 wt % | 0.65 wt % |
| 2 | 3 wt % | — | — | 9.08 wt % | 0.65 wt % |
| 3 | 5 wt % | — | — | 9.08 wt % | 0.65 wt % |
| 4 | 10 wt % | — | — | 9.08 wt % | 0.65 wt % |
| 5 | — | 1 wt % | — | 9.08 wt % | 0.65 wt % |
| 6 | — | 3 wt % | — | 9.08 wt % | 0.65 wt % |
| 7 | — | 5 wt % | — | 9.08 wt % | 0.65 wt % |
| 8 | — | 10 wt % | — | 9.08 wt % | 0.65 wt % |
| 9 | — | — | 1 wt % | 9.08 wt % | 0.65 wt % |
| 10 | — | — | 3 wt % | 9.08 wt % | 0.65 wt % |
| 11 | — | — | 5 wt % | 9.08 wt % | 0.65 wt % |
| 12 | — | — | 10 wt % | 9.08 wt % | 0.65 wt % |

Note:
— indicates that the component is not contained.

### Embodiment 1

1) Uniformly mixing raw alloy powder.

2) Importing the shape of a product needing to be printed into a computer control system, printing the alloy powder and glue in a 3D printer in an alternate spraying molding mode to obtain a blank with needed shape. Wherein the alloy powder is loaded into a metal charging barrel of the 3D printer, and the glue is loaded into a glue charging barrel in the 3D printer, the alternate spraying comprises the following steps: uniformly paving a layer of alloy powder on a powder bed, and then spraying a layer of glue on the layer of alloy powder, and then spraying a layer of alloy powder on the glue layer, and then spraying a layer of glue; the alloy powder and glue are alternately sprayed to obtain the blank. The glue is water-based low-molecular alcohol glue.

3) Drying the blank obtained in the step 2), and then carrying out degreasing and sintering on the blank in a protective atmosphere or vacuum. Wherein the blank is dried in the air at 120° C. for 4 h. The dried blank is degreased and sintered in the protective atmosphere or vacuum at 350° C. for 2 h.

4) Sintering the blank obtained in the step 3) in the protective atmosphere or vacuum at a high temperature of 620° C. and then cooling to room temperature. Wherein the blank is sintered in the protective atmosphere or vacuum at 620° C. for 12 h. The shielding gas is inert gas.

The embodiments 2-12 are prepared using a method same as the embodiment 1, and the mechanical properties and corrosion rates thereof are detected.

TABLE 2
Comparison of mechanical property and corrosion rate

| | Compressive | Corrosion Rate |
|---|---|---|
| Embodiment | Strength (MPa) | (mm/a 93° C.) |
| Embodiment 1 | 374 | 1,542 |
| Embodiment 2 | 401 | 2,174 |
| Embodiment 3 | 432 | 3,182 |
| Embodiment 4 | 314 | 7,876 |
| Embodiment 5 | 377 | 5,253 |
| Embodiment 6 | 407 | 6,683 |
| Embodiment 7 | 440 | 9,091 |
| Embodiment 8 | 279 | 18,621 |
| Embodiment 9 | 376 | 2,935 |
| Embodiment 10 | 414 | 3,648 |
| Embodiment 11 | 445 | 4,926 |
| Embodiment 12 | 292 | 10,925 |

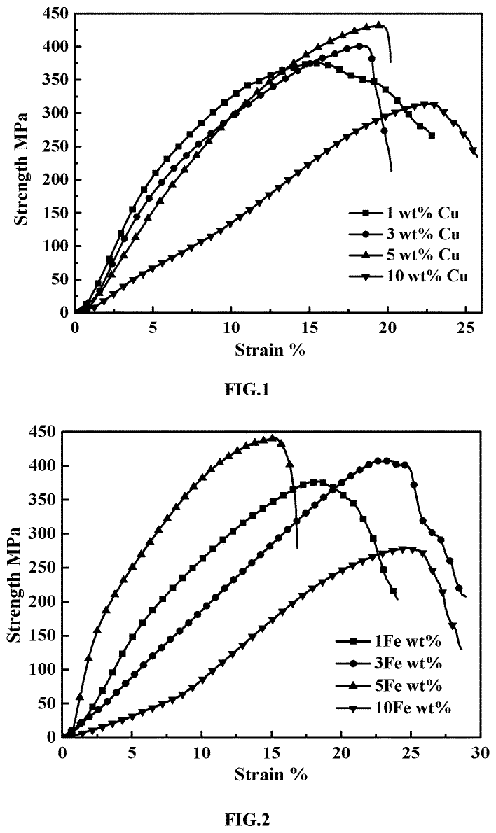

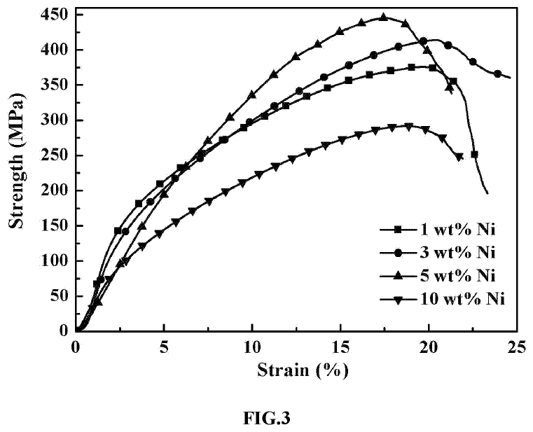

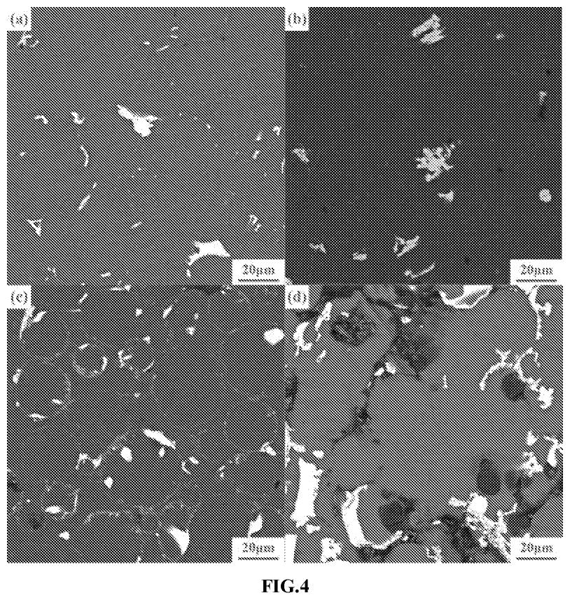

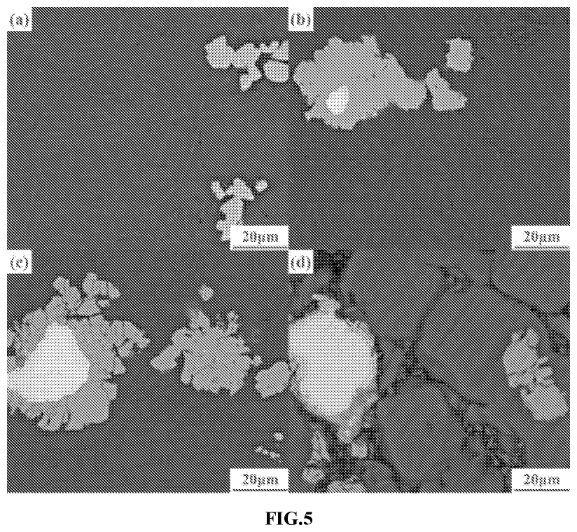

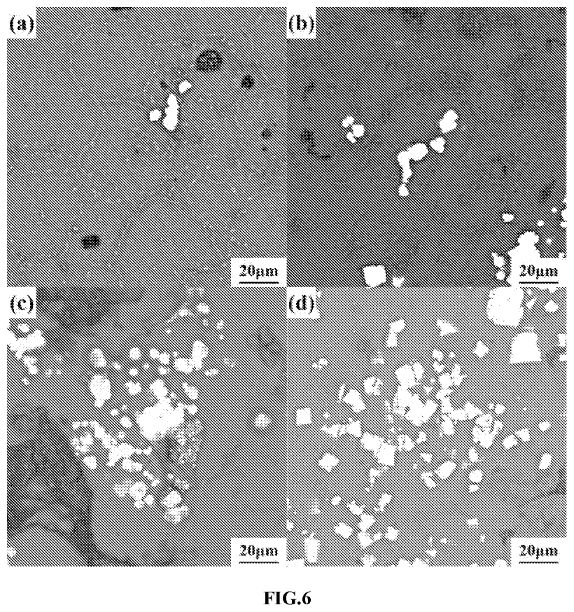

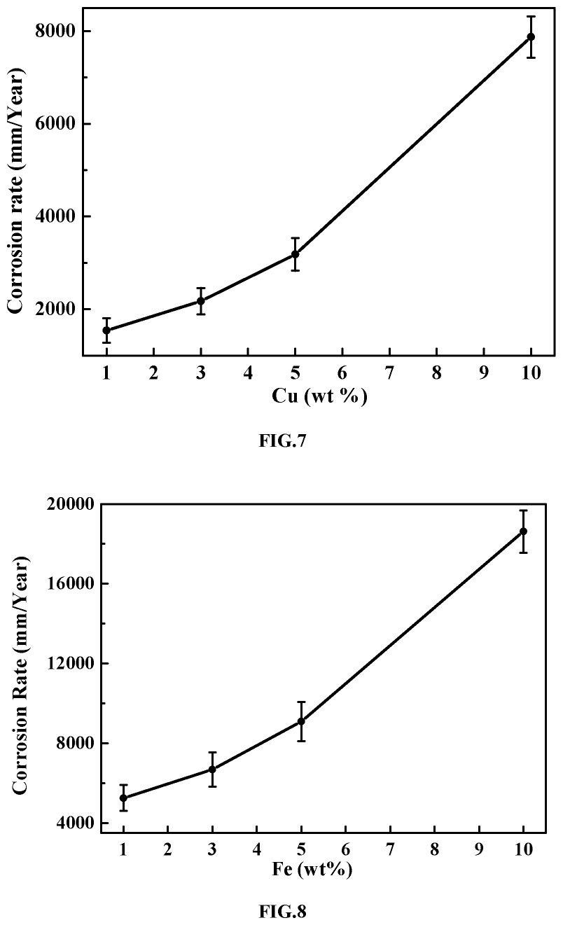

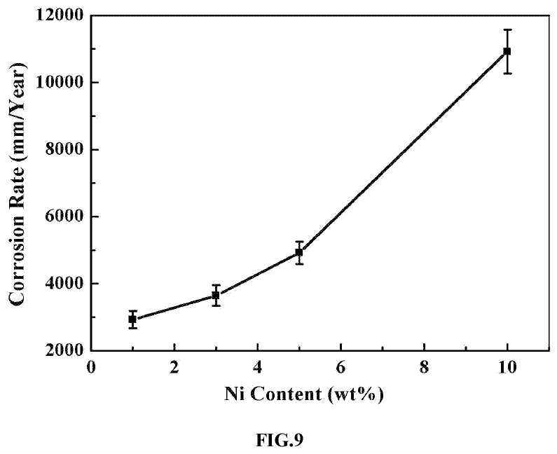

With reference to FIG. 4 to FIG. 6, it can be seen that the number of bright white second phases are gradually increased as the use amount of the Cu, Fe and Ni elements increase. As can be seen from Table 2 in conjunction with FIG. 1 to FIG. 3, the compressive strength of the embodiment is in a parabolic change along with the increase of the use amount of Cu, Fe and Ni elements, the compressive strength is obviously improved in the early stage, and the compressive strength of the sample is the maximum when the adding amount of these elements is 5 wt %, and the compressive strength is obviously reduced after the use amount exceeds 5 wt %; while the corrosion rate is always in a rising state, and such situation can be well proved with reference to the FIG. 7-FIG. 9. Therefore, it can also be seen that, according to the actual needs of use, it is possible to ensure a higher compressive strength of the additive material while also having a faster corrosion rate. When the Fe element is added in the additive material, the compressive strength and the corrosion rate of the additive material are significantly superior to those of Cu and Ni, and when the use amount of the Fe is 5 wt %, the compressive strength reaches 440 MPa, and the corrosion rate is up 9,091 mm/year. The alloy sample prepared by the preparation process has the effect of second phase reinforcement, and these reinforced phases can improve the corrosion efficiency of the alloy at the same time. In addition, the alloy prepared in accordance with the present disclosure has certain voids, can be self-densified in a high-pressure environment instead of fragmentation, has a large contact area with the fracturing fluid due to the voids thereof, and has a higher degradation rate than that of a traditional fracturing product; and the extraction efficiency can be effectively improved.

It needs to be noted that the above embodiments are only used to illustrate the technical solution of the present invention instead of limiting. It should be understood by those of ordinary skill in the art that modifications or equivalent substitutions made to the technical solution of the present disclosure without departing from the spirit and scope of the technical solutions shall be all encompassed within the scope of the claims of the present disclosure.

1-9. (canceled)

10. A 3DP preparation process of a high-strength rapid-dissolving magnesium alloy for an underground temporary plugging tool, comprising the following steps:
1) uniformly mixing ingredients of material components;
2) importing the shape of a product needing to be printed into a computer control system, and printing alloy powder and glue in a 3D printer in an alternate spraying molding mode to obtain a blank with the needed shape;
3) drying the blank obtained in the step 2) and then carrying out degreasing and sintering on the blank in a protective atmosphere or vacuum; and
4) sintering the blank obtained in the step 3) in the protective atmosphere or vacuum at a high temperature of 560° C.-680° C. and then cooling to a room temperature.

11. The 3DP preparation process of the high-strength rapid-dissolving magnesium alloy for the underground temporary plugging tool according to claim 10, wherein in the step 1) the alloy powder is loaded into a metal charging barrel in the 3D printer, and the glue is loaded into a glue charging barrel of the 3D printer, the alternate spraying comprises the following steps: evenly paving a layer of alloy powder on a powder bed, and then spraying a layer of glue on the layer of alloy powder, and then spraying a layer of alloy powder on the glue layer, and then spraying a layer of glue; the alloy powder and the glue are alternately sprayed to obtain the blank.

12. The 3DP preparation process of the high-strength rapid-dissolving magnesium alloy for the underground temporary plugging tool according to claim 10, wherein in the step 3), the blank is dried in the air at 70° C.-160° C. for 2 h-6 h.

13. The 3DP preparation process of the high-strength rapid-dissolving magnesium alloy for the underground temporary plugging tool according to claim 10, wherein in the step 3), the dried blank is degreased and sintered in the protective atmosphere or vacuum at 250° C.-400° C. for 0.5 h-10 h.

14. The 3DP preparation process of the high-strength rapid-dissolving magnesium alloy for the underground temporary plugging tool according to claim 10, wherein in the step 4), the blank is sintered in the protective atmosphere or vacuum at 580° C.-650° C. for 3 h-100 h.

15. The 3DP preparation process of the high-strength rapid-dissolving magnesium alloy for the underground temporary plugging tool according to claim 10, wherein the shielding gas is inert gas.

16. The 3DP preparation process of the high-strength rapid-dissolving magnesium alloy for the underground temporary plugging tool according to claim 10, wherein the glue is a water-based low-molecular alcohol glue.

17. A high-strength rapid-dissolving magnesium alloy for an underground temporary plugging tool, which is prepared through the 3DP preparation process according to claim 10, and is prepared from powder and auxiliary materials, wherein the powder comprises the following components in percentage by weight: one of Cu, Fe, Ni, and the use amount thereof is 0.1 wt %-20 wt %; Al is 0.5 wt %-20 wt %; Zn is 0.1 wt %-10 wt %; the rest is magnesium alloy powder, and the auxiliary material is glue.

18. The high-strength rapid-dissolving magnesium alloy for the underground temporary plugging tool according to claim 17, wherein in the step 1) the alloy powder is loaded into a metal charging barrel in the 3D printer, and the glue is loaded into a glue charging barrel of the 3D printer, the alternate spraying comprises the following steps: evenly paving a layer of alloy powder on a powder bed, and then spraying a layer of glue on the layer of alloy powder, and then spraying a layer of alloy powder on the glue layer, and then spraying a layer of glue; the alloy powder and the glue are alternately sprayed to obtain the blank.

19. The high-strength rapid-dissolving magnesium alloy for the underground temporary plugging tool according to claim 17, wherein in the step 3), the blank is dried in the air at 70° C.-160° C. for 2 h-6 h.

20. The high-strength rapid-dissolving magnesium alloy for the underground temporary plugging tool according to claim 17, wherein in the step 3), the dried blank is degreased and sintered in the protective atmosphere or vacuum at 250° C.-400° C. for 0.5 h-10 h.

21. The high-strength rapid-dissolving magnesium alloy for the underground temporary plugging tool according to claim 17, wherein in the step 4), the blank is sintered in the protective atmosphere or vacuum at 580° C.-650° C. for 3 h-100 h.

22. The high-strength rapid-dissolving magnesium alloy for the underground temporary plugging tool according to claim 17, wherein the shielding gas is inert gas.

23. The high-strength rapid-dissolving magnesium alloy for the underground temporary plugging tool according to claim 17, wherein the glue is a water-based low-molecular alcohol glue.

24. The high-strength rapid-dissolving magnesium alloy for the underground temporary plugging tool according to claim 17, wherein the Cu powder, the Fe powder, and the Ni powder are 150 meshes, and the magnesium alloy powder is 25-500 microns.

25. The high-strength rapid-dissolving magnesium alloy for the underground temporary plugging tool according to claim 18, wherein the Cu powder, the Fe powder, and the Ni powder are 150 meshes, and the magnesium alloy powder is 25-500 microns.

26. The high-strength rapid-dissolving magnesium alloy for the underground temporary plugging tool according to claim 19, wherein the Cu powder, the Fe powder, and the Ni powder are 150 meshes, and the magnesium alloy powder is 25-500 microns.

27. The high-strength rapid-dissolving magnesium alloy for the underground temporary plugging tool according to claim 20, wherein the Cu powder, the Fe powder, and the Ni powder are 150 meshes, and the magnesium alloy powder is 25-500 microns.

28. The high-strength rapid-dissolving magnesium alloy for the underground temporary plugging tool according to claim 21, wherein the Cu powder, the Fe powder, and the Ni powder are 150 meshes, and the magnesium alloy powder is 25-500 microns.

29. The high-strength rapid-dissolving magnesium alloy for the underground temporary plugging tool according to claim 22, wherein the Cu powder, the Fe powder, and the Ni powder are 150 meshes, and the magnesium alloy powder is 25-500 microns.
